(19) United States
(12) Patent Application Publication
(10) Pub. No.: US 2007/0106581 A1
(43) Pub. Date: May 10, 2007

(54) SYSTEMS AND METHODS FOR A FINANCIAL SERVICES REWARD PROGRAM

(76) Inventors: Jeffrey Mitchell, Rancho Santa Fe, CA (US); Philip Mickelson, Rancho Santa Fe, CA (US)

Correspondence Address: Vista IP Law Group LLP, 2040 MAIN STREET, 9TH FLOOR, IRVINE, CA, 92614, US

(21) Appl. No.: 11/535,813

(22) Filed: Sep. 27, 2006

Related U.S. Application Data
(60) Provisional application No. 60/735,025, filed on Nov. 8, 2005.

(51) Int. Cl. G06Q 40/00

(52) U.S. Cl. 705/35

(57) ABSTRACT

Systems and method for implementing a financial services benefit reward program, e.g. a credit card or debit card reward program, for a plurality of participants comprises the steps of determining a program fee based on a financial transaction by a participant; contributing at least a portion of said program fee called a contribution amount to a group insurance investment account in which each participant has a participant interest; and adjusting the participant's participant interest in the group insurance investment account based on the amount of said contribution amount. The method may also comprise restricting access to the participant interest until after a set period of time, imposing a penalty for early withdrawal, and/or utilizing an insurance investment plan having advantageous tax treatment.

### RELATED APPLICATIONS

This application claims the benefit of U.S. Provisional Patent Application Ser. No. 60/735,025, filed Nov. 8, 2005, pursuant to 35 U.S.C. Section 119, and any other applicable laws. The aforementioned application is hereby incorporated by reference herein in its entirety.

### FIELD OF THE INVENTION

The invention relates generally to the field of financial services, and more specifically to financial services customer rewards for retirement and health benefit services.

### BACKGROUND

Presently, many companies offer incentive or loyalty programs that are centered on merchandise or service premiums. The amount of merchandise or services earned through these “reward” programs is calculated based on a preset percentage of purchases (i.e. $0.05 per $1, 1 point per $1 spent, etc.) made by the customer using the company's credit card or membership. However, many of these rewards have become commonplace and it has become difficult for the typical customer to distinguish between them. As such, many of the present reward programs have become an ineffective way for companies to attract new customers and/or retain current customers of their services. Further, marketing campaigns and shifting reward offers have in many cases resulted only in the exchange of customers between companies without a significant net gain in market share. As a result of difficulties redeeming rewards for indirect benefits such as goods or services (e.g., airline frequent flier program blackout dates), and the inadequacy of direct benefits (e.g., cash back or savings account offers) to compel customers to change their company loyalty, these companies will likely continue in a pattern where no significant shift in market-share will result from these various initiatives.

As such, methods and apparatuses are needed in the financial services industry wherein customer loyalty is rewarded with critical lifestyle incentives such as retirement savings and health benefits. For example, instead of earning points or credit toward the purchase of goods and services, a customer would earn money which may then be deposited on their behalf into a designated account. This designated account may be a new type of Supplemental Social Security Account whereby its investment holdings will receive tax-deferral as they grow over time. This money would then be invested for a set period of time, to provide an expected rate of return. At the end of the time period, each customer would receive access to his/her proportionate lump sum in an individual account to apply toward various lifestyle-critical benefits. As a result, a customer would attribute a higher perceived value to the financial services company and the reward program as compared to the often cumbersome reward programs that are currently offered. Further, such a method may also be utilized for competing with customer loyalty and reward programs in industries outside of the financial services industry.

### SUMMARY

In accordance with the present invention, a system and method for a financial services reward program is provided in which rewards are earned by a participant for making qualifying reward accruing financial transactions (e.g. credit card or debit card purchases), and the rewards are contributed to a group investment account in which the participant has a beneficial interest. In one innovative aspect of the present invention, the group investment account is a group insurance investment account.

In general, the rewards program is implemented by a program operator, which can be a financial services provider such as a bank, credit card issuer, retailer or other commercial entity, or alternatively, the program operator can partner with such providers. The financial services provider processes financial transactions, such as credit card or debit card purchases or cash advances/withdrawals, for its customers. The customers of the financial services provider are enrolled in the rewards program and become participants in the program.

In one embodiment of the present invention, each time a participant completes a financial transaction which qualifies under the rewards program, such as a credit card purchase transaction, a rewards program fee is determined. For example, for a credit card transaction, there is typically a transaction fee charged to the vendor or merchant by the credit card issuer that ranges from about 1%-3% of the transaction amount. From this transaction fee, a portion of the fee can be used to cover the credit card issuer's costs for providing the credit card services, e.g. one-third to one-half of the transaction fee, and a portion of the transaction fee is the program fee which may used for the rewards program.

Next, at least a portion of the program fee is earmarked as a contribution amount which is contributed to a group insurance investment account. The group insurance investment account may be, for example, a group variable universal life insurance account, a group universal life insurance account, or the like, in which each participant in the rewards program is provided with a participant interest. Next, the participant interest of the participant making the qualifying financial transaction is adjusted based on the amount of the contribution amount. For instance, the contribution amount may be a fixed percentage of the program fee and the remainder of the program fee may be allocated to pay administrative expenses to the program provider. Thus, the transaction fee is a percentage of the financial transaction amount, the program fee is a percentage of the transaction fee, and the contribution amount is a percentage of the program fee. Consequently, the contribution amount may be a percentage of the transaction amount, although the present invention is not limited to such a structure.

In another aspect of the present invention, the contribution to the group insurance investment account is allocated partially to a life insurance component of the group insurance investment account and partially to a managed investment account. In one embodiment, the life insurance account may be provided by a first company and the managed investment account may be provided by a separate second company. Alternatively, a single company may provide both the life insurance account and the managed investment account.

In still another feature of the present invention the participant's participant interest in the group investment account can be restricted such that the participant cannot access or borrow against the account until after set period of time. For instance, the participant's interest may be restricted until after at least 10 years, or 5 years, or 2 years from a base date, such as the date the participant is first enrolled in the rewards program or the date of the first contribution to the group insurance investment account. In the alternative, an early withdrawal penalty may be used to encourage long-term participation by participants in the program. In this way, if a participant withdraws or accesses his/her participant interest before the set period of time, then a financial penalty will be assessed, which could be proportionate to the amount withdrawn early. The penalty could be assessed by deducting the penalty from the amount being withdrawn, or from the amount of the remaining participant interest.

In still another aspect of the present invention, a participant may make additional cash contributions to the group insurance investment account, in addition to the contribution amounts made as a result of making qualifying financial transactions.

In another embodiment of the present invention, a method of implementing a financial services benefit reward program comprises the steps of providing a plurality of parameters associated with a financial transaction as a new entry in a transactions database; determining at least one transaction fee associated with the new entry; determining a benefit allotment associated with the transaction fee, wherein the benefit allotment is a predetermined percentage of the transaction fee; and allocating the benefit allotment to at least one managed account.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 illustrates a system for implementing a reward benefit program according to one or more embodiments of the invention.

### DETAILED DESCRIPTION OF SEVERAL EMBODIMENTS

It will be appreciated that the following description is intended to refer to specific embodiments of the invention, some of which are selected for illustration in the drawings, and is not intended to define or limit the invention, other than in the appended claims.

The system and method for a financial services reward program according to the present invention provides an innovative and useful program in which participants earn rewards for making qualifying financial transactions, and the rewards are contributed to a group insurance investment account. The invention is especially advantageous when employed as a retirement planning tool because of its potential tax advantages and long-term incentives, though the invention is not necessarily limited as such.

As an overview, the rewards program is implemented by a program operator. As further described in detail below, the program operator may be a financial services provider which processes financial transactions for its customers, such as a bank, credit card issuer, retailer or other commercial entity. Those customers that are enrolled in the rewards program would then be participants in the program. In this case, the program operator would administer the rewards program and also process the financial transactions for the participants.

Alternatively, the program operator can be an entity separate and apart from the financial services provider and instead the program operator would partner with one or more financial service providers. In such case, the financial services provider would still process the financial transactions which accrue rewards, and would also provide the program operator with the financial transaction data necessary to administer the program. The program operator would then administer the rewards program.

In either case, administration of the rewards program may include one or more of the following: determining or calculating the rewards earned by participants; providing the group investment insurance account or partnering with a provider of the group insurance investment account; preparing account statements for the participants and sending the statements to the participants; marketing and advertising the rewards program; administering a cash contribution program as described below; and/or sending the contribution amounts to the provider of the group insurance investment account. Also, in either case, the financial services provider could be designated to perform one or more of these tasks, such as preparing and sending statements to the participants, especially since the financial services provider is generally already sending periodic statements and/or bills to the participants.

For illustration of one embodiment of the present invention, a typical system and method will be described in relation to credit card transactions, with the understanding that the present invention is not limited to credit card processing system and methods, but instead may be implemented with any system and method for financial transactions in which a reward may be provided. In this example, a customer has a credit card from a financial services provider which comprises a credit card issuer. The customer is enrolled in the rewards program and is therefore a participant in the rewards program.

The participant utilizes the credit card to engage in a financial transaction such as purchasing goods or services from a merchant accepting the credit card. For each transaction, card, it may be determined whether the transaction qualifies for a reward under the rewards program. In some cases only certain transactions may be qualified for a reward. For example, cash advances may be excluded from qualifying for a reward, whereas all purchases of goods and services may qualify. Qualification for a reward can be based on any desired criteria, including the particular merchant, type of merchant, type of product or service, time of transaction, or other suitable criteria. Determining whether a transaction qualifies for a reward is not required by the present invention, and if desired, all transactions can earn a reward.

As is known by those of ordinary skill in the field of credit card transactions, for each credit card transaction, the credit card issuer charges the merchant a transaction fee. Transaction fees vary, but are typically about 1%-3% of the transaction amount. From this transaction fee, a portion of the fee is allocated to the rewards program as a program fee. The remainder of the transaction fee can be retained by the credit card issuer as income for providing the credit card services. As an example, one-third to one-half of the transaction fee may be allocated as income to the credit card issuer, and the remainder may be allocated to the program fee.

Although it provides a simple and straightforward method of determining the program fee, the program fee need not be a set percentage of the transaction amount or the transaction fee, but can be determined based on other criteria of the financial transaction. For instance, the program fee can be a set amount for each financial transaction, such as $1.00 per transaction. Or, the program fee can be based on ranges of the transaction amount, like $1.00 for transactions from $100-$200, $2.00 for transactions between $201-$300, and so on.

Next, at least a portion of the program fee is allocated as a contribution amount which is contributed to a group insurance investment account (as described below, certain expenses, fees and/or compensation may be deducted from the program fee). The group insurance investment account may comprise, for example, group variable life insurance, group universal life insurance, group variable universal life insurance (GVUL), or similar group insurance plans. These types of group insurance plans include a life insurance component (also referred to as a group life insurance policy) and an investment component (also referred to as a group investment account). Group insurance investment plans provide many advantages over other types of investments. For one, the use of a “group” account reduces the administrative costs of the account because many aspects do not have to be managed individually for each of the many participants in the program. As an example, the life insurance component of the life insurance investment account can be “guaranteed issue” so that individual risk assessments do not have to be made for each participant. Instead, all participants qualify for the life insurance and costs associated with any high risk participants will be balanced by the large number of participants in the program.

Moreover, the insurance investment plan can be structured to provide not only tax-deferred growth in the investment component, but also tax-free returns by utilizing a “wash-loan” provision unique to insurance investments. The requirements for such insurance investment plans and their benefits are known by those of ordinary skill in the art, so they will only be briefly described herein. As for the requirements to qualify for tax-deferred treatment of the investment gains, the contribution amount allocated to the life insurance component must satisfy either the “cash value accumulation” test or the “guideline premium and cash value corridor test.” Therefore, the life insurance component should include automatic increases in death benefit. In order to maximize the investment component, insurance costs should be kept to a minimum by structuring the life insurance premiums to track the minimum non-MEC guidelines (i.e. the least amount of premium charge necessary to sustain the least amount of death benefit calculated to satisfy the requirements of Section 7702 of the Tax Code, which, with actuarial certainty, will not cause the policy to “endow” in any year prior to age 100.) In addition, the participant cannot have any legal, direct, or indirect ownership interest in any specific investment in the investment account. The participant can only have a contractual interest or claim against the investment account. If these requirements are met, the investment gains in the group insurance investment account will not be taxable in the year that the gain is realized. Furthermore, participants can realize a tax-free return of their interest in the investment component through a “wash-loan.” A wash-loan allows the participant to borrow up to the value of their participant interest, and the same amount of interest charged for the loan is credited to the participant interest, so that there is no “net” cost to the borrower for the loan (i.e. the borrower does not have to make any payment on the loan).

Another benefit of utilizing a group insurance investment plan is the ability to market and sell related insurance products such as riders and options. For example, additional term insurance can be marketed and sold to participants. The term life insurance can be converted into the group insurance plan for the benefit of the participant in the same manner that stand-alone life insurance policies are convertible.

The investment component, or group investment account, can be a managed investment account provided by the provider of the insurance investment plan or it can be provided by a separate company. The managed investment account can include any suitable investments such as stocks, bonds, mutual funds, money market instruments, instruments of financial institutions such as certificates of deposit, instruments of governmental bodies, U.S. Government securities, real estate, commodities, and the like. Preferably, all of the investments qualify for the advantageous tax treatment described above for insurance investment plans.

As one example of many possibilities, the investment account may be configured to provide the higher of (i) a fixed minimum rate of return, or (ii) an adjustable rate based on the performance of a stock market index such as the S&P 500. The fixed minimum rate of return may be about 3-4% or a reasonable rate that can be obtained through an investment having minimum risk such as U.S. Government bonds. The adjustable rate may be some percentage, less than 100%, of the rate of return of the selected index. In this way, the participants can gain the benefit of a favorable stock market, but will never realize less than a fixed return and will not suffer any losses if the index loses value. Those of ordinary skill in the relevant art know how to structure this type of investment plan.

As another example, the investment account may consist of a blended portfolio of equities, fixed income securities, managed professionally to deliver long-term returns. Such an account could suffer losses and would provide no guaranteed or minimum annual return.

In order to minimize the administrative costs of the group investment account, the plan can be structured so that participants cannot choose among investments or investment strategies. Alternatively, the plan can be structured such that participants can choose among broad investment strategies or even among a selection of particular investments, such as the investments listed above.

Therefore, in contributing the contribution amount to the group insurance investment account, a portion of the contribution amount is allocated to the group life insurance component and a portion is allocated to the group investment account. Preferably, the allocation is made consistent with the tax requirements described above.

Finally, the participant interest of the participant making the qualifying financial transaction is adjusted based on the amount of the contribution amount. As an example, the contribution amount may be the entire program fee, or it may be a fixed percentage of the program fee and the remainder of the program fee may be allocated to pay administrative expenses and/or compensation to the program provider. Thus, in the case of the credit card example, the transaction fee is a percentage of the financial transaction amount, the program fee is a percentage of the transaction fee, and the contribution amount is a percentage of the program fee. Consequently, the contribution amount may be a percentage of the transaction amount, although the present invention is not limited to such a structure.

In order to further reduce the administrative costs of the group insurance investment plan, and also to encourage long-term saving by each participant, the participant's participant interest in the group investment account can be restricted such that the participant cannot access or borrow against the account until after a set period of time. The participant's interest may be restricted until after at least 10 years, or 5 years, or 2 years from a base date. The base date can be the date the participant is first enrolled in the rewards program, the date of the first contribution to the group insurance investment account, or other suitable date. Alternatively, the participant's interest may be restricted until the participant reaches a certain age, such as a retirement age, or the age of 65, or 70 or 75.

In the alternative, rather than a flat restriction on withdrawal, an early withdrawal penalty period may be used to encourage long-term participation by participants in the program. In this way, if a participant withdraws or accesses his/her participant interest before the set period of time, then a financial penalty will be assessed, which could be proportionate to the amount withdrawn early. The penalty could be assessed by deducting the penalty from the amount being withdrawn, or from the amount of the remaining participant interest.

Once the restriction period (or early withdrawal penalty period) has passed, the participants may be given one or more of the following options: re-enroll for another investment period; elect to receive the value of their participant interest in a lump sum amount; take a lump sum distribution of their participant interest and start a new account; transfer the account to another person such as a spouse, child, grandchild or other relative (if the transferee is already a participant, the amount can simply be added to their pre-existing participant interest); or take a loan on their participant interest and retain their account.

In order to allow participants to take further advantage of the rewards program, a participant may be allowed to make additional cash contributions to the group insurance investment account, in addition to the contribution amounts made as a result of making qualifying financial transactions. This allows a participant to further build the value of his/her participant interest in the group insurance investment. The system and method can be configured such that the cash contributions are made on a periodic schedule, such as monthly, weekly, daily, etc. Alternatively, the contributions can be made on an as-desired/unscheduled basis. Alternatively, the program operator can designate a window of time each year (e.g. the beginning or end of calendar year) for participants to make such contributions. This allows the program operator, and group insurance investment provider(s) with a much easier means of managing cash inflows and making investments.

Another cash contribution program according to the present invention is a Dollar-A-Day™ program in which a participant can add $1 per day directly as a contribution amount. The additional cash contributions can be charged directly to a credit card associated with the rewards program. Cash contributions can also be funded through an annual tax-refund contribution program in which all, or an elected portion, of a participant's tax-refund is contributed as a contribution amount. As an added bonus, cash contributions can be exempted from any of the administrative, compensation and/or load fees charged by the program operator and/or the provider of the investment account.

The program operator, insurance plan provider and investment account provider can be compensated for their part in the reward program from several different sources. For one, as described above, a portion of the program fee can be allocated to the program operator as compensation for administering the rewards program. The investment account provider may deduct a fee, such as a load, on the amount of the contribution amounts contributed to the investment account. The investment account provider may also be paid a management fee for managing the investment account which is deducted from the assets of the investment account. The management fee may be an annual fee calculated as a percentage of the total assets under management (AUM). The program operator may also be paid a fee from the investment account which is calculated as a percentage of the total assets under management. The insurance plan provider is primarily compensated based on its fee for the life insurance provided to the participants. This fee comes from the portion of the contribution amount allocated to the life insurance component of the group investment plan, as described above.

The method of the present invention may also include that the program operator receives additional funding from its partners—the insurance plan provider and/or the investment account provider. This funding may include payments from the respective advertising budgets of the insurance plan provider and investment account provider for advertising and promoting the rewards program. Providers may also make payments to the program operator for being made partners in the rewards program.

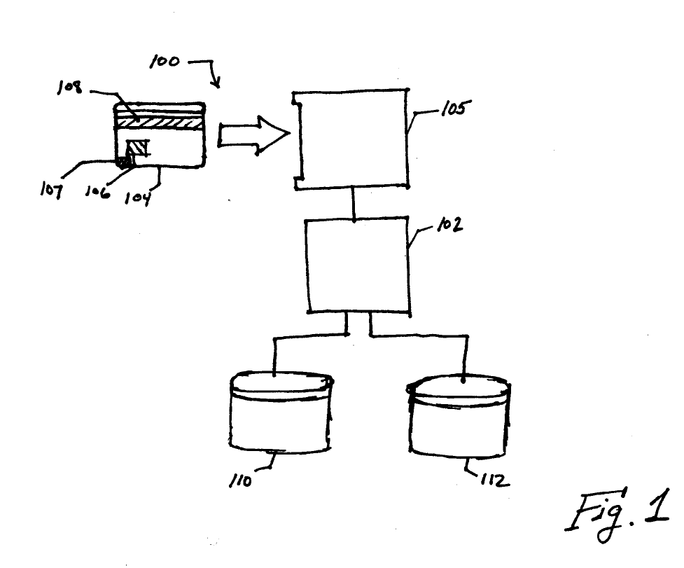

The rewards program of the present invention can be implemented on any suitable system for processing financial transactions such as credit or debit card transactions, with the necessary modification and enhancements for performing the steps of the methods described herein. As an example, the system described below in relation to FIG. 1 can be utilized to implement the present invention. All of the features of the above embodiment may be implemented in the additional embodiments described below, where feasible, and vice versa, according to the present invention.

In the figure referenced below, in which like reference numerals indicate like elements, additional embodiments of methods and apparatuses for implementing a financial services benefit reward program are shown. For the purposes of this description, a financial services benefit reward program comprises one or more financial benefits that may be allocated to at least one managed account. A financial services benefit may include a pooled account for all participants in the benefit program or a plurality of individual accounts. For example, a financial services benefit may include a long-term/“retirement” account, a health benefit account or funds allocated for the payment of health insurance premiums or other lifestyle-critical benefits.

FIG. 1 illustrates a system 100 for implementing a financial services benefit reward program according to additional embodiments of the present invention. A processor 102 may be programmed to perform the various operations herein, as will be described in more detail below. Further, while the various embodiments herein are described as being performed by a single processor 102, it should be understood that such descriptions may be simplified for ease of understanding. One skilled in the art will note that the various steps may be implemented by a single processing device or by a plurality of processing devices working independently or in conjunction with each other. Further, the processing aspects of the various embodiments may be implemented by any combination of hardware, software and/or firmware. In one embodiment, the system 100 may include a plurality of processors 102, hardware and/or software for performing various functions such as enhancing the security and utility of the system. For example, the system 100 may include redundancies for safeguarding the financial services networks of third party participants such as smart card providers.

A smart card 104 as defined herein includes a credit card which has the capability to store parameters relating to a cardholders In various embodiments, the smart card 104 may be in communication with the processor 102 via a card reader device 105. The smart card 104, as with a typical credit card, will include a magnetic stripe 108, whereupon a plurality of “tracks” are utilized to transmit parameters about the cardholder and/or merchant to the processor for each financial transaction (e.g., a cardholder purchase). Unlike other credit cards, however, the magnetic stripe 108 on the smart card 104 may include an additional track or tracks that enable monitoring of various aspects of the benefit reward program. For example, a fourth track on the magnetic stripe 108 of the smart card 104 may monitor the smart card provider and/or the vendor's fulfillment of their per transaction obligation to the reward program. By utilizing more than the industry standard three tracks on its magnetic stripe 108, the smart card 104 will provide seamless operation of the benefit reward program while simultaneously providing heightened security per transaction. Alternatively, or in addition to one or more tracks, each smart card 104 may contain a “smart chip” 106 with a radio frequency (RF) transmitter for monitoring transactions and communicating with the processor 102. This “smart chip” 106, by virtue of its RF transmitter, will provide cardholders more efficient, virtually instantaneous, secure transactions through streaming communication between the smart card 104 and the processor 102.

The additional tracks on the magnetic stripe 108 on the smart card 104 are operable to perform cardholder account verification for each transaction. For example, the additional fourth track on the magnetic stripe 108 may incorporate a security code protected by a multi-bit word and/or algorithm to serve as the trigger for access to the various functions of the processor 102; from tracking cardholder purchases to transmitting parameters associated with a transaction to a managed account such as, for example, a retirement account or a health benefit account. In another embodiment, the smart card 104 may include a bio-recognition security measure 107 for cardholder identification. For example, for each financial transaction, a cardholder's identity may be verified via a thumbprint scanning device embedded in the smart card 104 or by associating the smart card 104 with a reader device 105 that is operable to verify biometric or other information. This bio-recognition security measure 107 will be linked to the fourth (or even a fifth) track on the magnetic stripe 108 which will enable each transaction by verifying and communicating the cardholder's identity to the card reader device 105. Powering the bio-recognition security measure 107 will be a solar luminescence chip 109 which may be located, for example, in the lower right corner of the back of the card. The chip 109 will require only brief exposure to a light source to generate adequate power for the security feature 107.

If security access is granted, the processor 102 receives a plurality of parameters from the smart card 104 via the plurality of tracks on the magnetic stripe 108 that are associated with the financial transaction for the creation of a new entry in a transactions database 110. The processor 102 may then determine at least one transaction fee associated with the new entry. For example, the transaction fee may be based on the type of transaction, purchase amount, etc. When the transaction fee is determined, the processor 102 may then determine a benefit allotment associated with the transaction fee. For example, the benefit allotment, or amount of the transaction that is designated for a reward benefit program, may be predetermined by the cardholder, a program operator, the smart card provider or another entity. When the benefit allotment (also called a contribution amount herein) is determined, the processor 102 may then allocate the benefit allotment to at least one managed account database 112, which may be incorporated within the system 100 or be situated at an accessible location that is remote from the system 100. As a result, the cardholder receives credit for the transaction and will eventually receive a managed account reward as per the rules of the program.

There are various models that a program operator may choose from to operate a reward benefit program using the system and methods described above. In one scenario, the program operator may partner with an established financial services provider such as, for example, a credit card company, whereby that company may leverage its position in the marketplace by utilizing the system. For example, some or all of the functions of the system 100 may be performed through the utilization of an existing financial services network. In one embodiment, a period of exclusivity may be granted to a credit card company to enhance its ability to acquire market-share from its competitors arising from the utilization of the system 100. In this way, the program operator will essentially be attaching its own “brand” to that of the established credit card company.

Under this scenario, the financial diagram and its mechanics will be as follows:
Current fees charged to vendors by credit card companies on a per transaction basis range from 2-3%.
The program operator may receive 0.5% of each transaction from the vendor, and/or 0.5% of each transaction from the credit card company, thus generating a total 1% fee per transaction to be paid to the program operator. Note that this fee to the program operator is comparable to the fees that credit card companies typically make for rewards programs and/or marketing. A portion of the 1% fee may be made available to the program operator for administration, promotion, and operational overhead at the program operator's discretion.
Assuming that the average targeted cardholder charges $1667 per month, 1% would total approximately $200 per year.
Assuming that in the first year, the program operator's reward program would garner an average of 1 million cardholders to the credit card company's new credit card.
Based on the above assumptions, estimated fees collected by the program operator in year 1 will be $200 million (=$200/yr×1 million cardholders).
The $200 million would be deposited into a pooled retirement account to be managed by the program operator's financial services partner (a large institutional investor) for a period of 10-15 years. A number of investment vehicles that provide tax deferral are being considered.
The program operator has researched several prospective financial services partners and observed that, historically, these large institutional investors have generated returns in the 8-12% range on their “long-term money” (i.e. 15+years).
A small portion of net annual contributions on behalf of cardholders would be paid/allocated to a benefits partner of the program operator's choice who may provide life and/or health insurance benefits to cardholders.
Additional annual funding for the program operator's operations and growth would come from its selected credit card company partner and insurance benefits partner. Between these two partners, the program operator would request up to 5% of each of their respective annual advertising budgets. This could be approximately $6-50 million from partners.
In this scenario, it is assumed that the program operator's financial services partner is able to achieve a 8% return over a 15 year period of uninhibited investment and that the cardholders would receive a return of up to 5% on all contributions.

In another scenario, the program operator would launch its own credit card, highlighting its unique reward program in a broad marketing campaign. In doing so, the program operator would necessarily either create its own transaction technology and management systems or acquire a smaller, existing credit card company and re-brand it under the program operator's name.

Under this scenario, the financial diagram and its mechanics will be as follows:
The program operator would charge vendors an industry standard per transaction fee of 2-3%.
The program operator would divert 1% of the vendor-paid transaction fee to the cardholder pooled retirement account and utilize the balance (i.e. 1-2%) for administration, promotion, and operational overhead. This 1-2% from the total transaction fee paid by vendor would help mitigate any shortfall from potentially lower contributions (because there won't be a credit card company partner) from partner advertising budgets.
Additional annual funding of the program operator's operations and growth would come from its selected insurance benefits partner and possibly its financial services partner. Between these two partners, the program operator would still anticipate being able to receive funds from those companies' annual advertising budgets totaling approximately $6-50 million.
Assuming that the average targeted cardholder charges $1667 per month, 1% of which would total approximately $200 per year.
Assuming that in the first year, the program operator's rewards program would gamer an average of 1 million cardholders to its new credit card. The program operator maintains that this assumption is still reasonable despite having no existing pool of credit cardholders to pull from. Instead, its cardholders will come from existing customers and employees of its financial and benefits partners, to whom those companies will market the program operator's credit card and unique rewards program as a value added offering. Further, promotion deals of the card may be made with individual companies to offer to both their employees and customers.
Based on the above assumptions, estimated fees collected by the program operator in year 1 would be $200 million (=$200/yr×1 million cardholders).
The $200 million would be deposited into a pooled retirement account to be managed by the program operator's financial services partner (a large institutional investor) for a period of 10-15 years. A number of investment vehicles that provide tax deferral are being considered.
Empirical research has determined that historically, large institutional investors have generated returns in the 8-12% range on their “long-term money” (i.e. 15+years).
A small portion of net annual contributions on behalf of cardholders would be paid/allocated to a benefits partner of the program operator's choice who may provide life and/or health insurance benefits to cardholders.
Income may also be derived from finance charges on balances carried by cardholders as per the traditional credit card business model.

In another scenario, the program operator may also offer a retirement savings program whereby cardholders will be able to add $1 per day directly into the pooled account with a financial services partner. These daily contributions would be accomplished by cardholders electing to have $1 charged to their card automatically. These charges may be exempt from any transaction fees, thereby ensuring that the full amount contributed will be invested in the account, again at an annualized return of up to 5% over a specified period of time. To mitigate the negative impacts of taxes in such accounts (especially in the instance of a parent establishing such an account for a child, etc.), tax-deferred investment vehicles such as variable annuities may be utilized.

The financial ramifications of this additional revenue stream to cardholders and the Company are displayed graphically below:

$1 per Day Savings Plan

| | 15 | 20 | 25 | 30 | 35 | 40 |
|---|---|---|---|---|---|---|
| | Years | Years | Years | Years | Years | Years |
| Assumed FSP Return (8%) | $10,703 | $18,039 | $28,818 | $44,656 | $67,927 | $102,120 |
| Return to CH (5%) | $8,270 | $12,673 | $5,402 | $25,463 | $34,615 | $46,297 |
| Revenues to CHR & B per CH | $2,433 | $5,367 | $10,527 | $19,194 | $33,312 | $55,824 |

In another scenario, the program operator intends to also offer cardholders the option of making one-time, annual additions to their account. As with the $1 per day program, these charges will be exempt from any transaction fees, thereby ensuring that the full amount contributed will be invested in the account. The program operator will provide a window of time each year (e.g. beginning or end of calendar year) for cardholders to make such contributions. Having such a designated time for account additions will provide the program operator's financial services partner with a much easier means of managing cash inflows and making investments.

In another scenario, the program operator intends to also offer cardholders the option of participating in an annual tax-refund contribution program. As with the $1 per day program, these charges will be exempt from any transaction fees, thereby ensuring that the full amount contributed will be invested in the account. Instead of spending their refund checks on consumable goods, cardholders will be encouraged to direct these funds into their accounts for long-term investment. As with the one-time addition described immediately above, this program would take place over a designated window of time each year (e.g. end of April to mid-May) to provide the program operator's financial services partner with a much easier means of managing cash inflows and making investments.

It is to be understood that features and aspects described with respect to any one or embodiments of the present invention may be implemented in any other embodiment, unless it is clear by their nature and function that they are incompatible.

A variety of modifications to the embodiments described will be apparent to those skilled in the art from the disclosure provided herein. Thus, the invention may be embodied in other specific forms without departing from the spirit or essential attributes thereof and, accordingly, reference should be made to the appended claims, rather than to the foregoing specification, as indicating the scope of the invention.

1. A method for a financial services reward program for a plurality of participants, comprising the steps of:
determining a program fee based on a financial transaction by a participant;
contributing at least a portion of said program fee, called a contribution amount, to a group insurance investment account in which each participant has a participant interest; and
adjusting the participant's participant interest in the group insurance investment account based on the amount of said contribution amount.

2. The method of claim 1, wherein said financial transaction is a credit card or debit card purchase transaction.

3. The method of claim 2, wherein said program fee is a percentage of said credit or debit card purchase transaction amount.

4. The method of claim 1, wherein said group insurance investment account comprises a group life insurance component and a managed investment component.

5. The method of claim 4, wherein said insurance investment account is one of a group variable universal life insurance account, or a group universal life insurance account.

6. The method of claim 4, wherein said insurance investment account provides tax deferral to the participant for any earnings of said insurance investment account.

7. The method of claim 1, wherein said participant's participant interest in the group investment account cannot be accessed or borrowed against by said participant until after a set period of time.

8. The method of claim 1, wherein said participants do not have any legal ownership interest in the assets of said group investment account.

9. The method of claim 1, further comprising the steps of:
receiving a cash contribution from the participant;
contributing at least a portion of said cash contribution to said group investment account; and
adjusting the participant interest in the group investment account based on the amount of said cash contribution.

10. The method of claim 9, wherein said cash contribution is made at predetermined time periods.

11. The method of claim 9, wherein a portion of the program fee is used to pay an administrative fee to a financial services reward program administrator, and a portion of the program fee is contributed to said group investment account as said contribution amount.

12. The method of claim 1, wherein said step of contributing said contribution amount to a group insurance investment account comprises the steps of:
contributing a portion of the contribution amount is allocated to provide the death benefit; and
contributing a portion of the contribution amount is directed to a managed investment component.

13. The method of claim 12, wherein said group life insurance policy is provided by a first company, and said managed investment component is managed by a second company which is different from said first company.

14. The method of claim 4 further comprising the step of:
providing the participant a loan based on the participant's participant interest in the group investment account.

15. The method of claim 14, wherein said loan is a wash-loan in which the participant is charged interest and a credit is applied to the participant's participant interest in the same amount as the charged interest.

16. The method of claim 1, wherein a transaction fee is charged for said financial transaction and said program fee is a portion of said transaction fee.

17. The method of claim 16, wherein said transaction fee is a percentage of the amount of said financial transaction and said program fee is a percentage of said transaction fee.

18. The method of claim 16, further comprising the step of:
deducting a portion of said program fee for payment of an administrative fee to a financial services program administrator.

19. The method of claim 18, further comprising the step of:
paying an administrative fee to a financial services program administrator based on the total assets under management in said group investment account.

20. The method of claim 19, further comprising the step of:
paying a management fee to an investment company which manages said group insurance investment account.

21. The method of claim 1, wherein said participant's participant interest in the group investment account cannot be accessed or borrowed against by said participant until after a set period of time without incurring a penalty.

22. The method of claim 21, wherein said penalty is a percentage of the total of the participant's participant interest.

23-59. (canceled)
